(19) United States
(12) Patent Application Publication
(10) Pub. No.: US 2024/0354144 A1
(43) Pub. Date: Oct. 24, 2024

(54) DATA ACCESS IN A COLLECTION OF COMPUTING NODES

(71) Applicant: HEWLETT PACKARD ENTERPRISE DEVELOPMENT LP, Spring, TX (US)

(72) Inventors: Vinay Devadas, San Jose, CA (US); Srikant Varadan, Fremont, CA (US); Christopher Joseph Corsi, Wake Forest, NC (US)

(21) Appl. No.: 18/305,481

(22) Filed: Apr. 24, 2023

(51) Int. Cl. G06F 9/455; G06F 3/06

(52) U.S. Cl. CPC G06F 9/45558; G06F 3/061; G06F 3/0659; G06F 3/0673; G06F 2009/45583

(57) ABSTRACT

In some examples, a first computing node receives a write request, where the first computing node is part of a collection of multiple computing nodes, and a plurality of virtual processors are executable in the multiple computing nodes to manage access of data in a shared storage system. In response to the write request, a first virtual processor at the first computing node sends, to a second virtual processor, a request for metadata stored by the second virtual processor. The first virtual processor updates an intent structure in a nonvolatile memory with information indicating an intent to write data for the write request. In response to the metadata received at the first virtual processor from the second virtual processor, a write of the data is initiated to cause storage of the data in the shared storage system.

### BACKGROUND

A storage arrangement can include a cluster of computing nodes that manage access of data in a shared storage system that is shared by the cluster of computing nodes. Each computing node of the cluster of computing nodes can execute one or more virtual processors, with each virtual processor managing access to a respective data partition in the shared storage system.

### BRIEF DESCRIPTION OF THE DRAWINGS

Some implementations of the present disclosure are described with respect to the following figures.

FIG. 1 is a block diagram of an arrangement that includes cluster of computing nodes, a shared storage system, and requester devices, according to some examples.

FIGS. 2A-2C are block diagrams of metadata structures according to some examples.

FIG. 3 is a flow diagram of a write handling process involving various virtual processors, in accordance with some examples.

FIG. 4 is a flow diagram of a read handling process involving various virtual processors, according to some examples.

FIG. 5 is a flow diagram of an anomaly handling process involving various virtual processors, according to some examples.

FIG. 6 is a flow diagram of a process of a recipient virtual processor, according to some examples.

FIG. 7 is a block diagram of a storage medium storing machine-readable instructions according to some examples.

FIG. 8 is a block diagram of a system according to some examples.

FIG. 9 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

A “virtual processor” can refer to a computing entity implemented with machine-readable instructions that are executable on a computing node. By managing access of data in different data partitions using respective different virtual processors executed in a cluster of computing nodes, data throughput can be improved when the virtual processors access data in parallel from a shared storage system. A “shared” storage system is a storage system that is shared (i.e., accessible) by any computing node of the cluster of computing nodes.

A data access request (write request or read request) can be received at a given computing node of the cluster of computing nodes. A virtual processor in the given computing node can be assigned to handle the data access request. The assigned virtual processor assigned to handle a given data access request may be referred to as a “source virtual processor” with respect to the given data access request. In some examples, the source virtual processor may not be the virtual processor that “owns” (i.e., manages access and/or updates to) metadata for the data that is the subject of the data access request. In some examples, the source virtual processor may not be the virtual processor that “owns” the data that is the subject of the request (i.e., that manages reading and writing of that data in the shared storage system). The virtual processor that owns metadata for data that is the subject of a given data access request may be referred to as a “metadata virtual processor” with respect to the given data access request, and the virtual processor that owns the data that is the subject of the given data access request may be referred to as a “data virtual processor” with respect to the given data access request.

Because different virtual processors may have different roles with respect data of a given data access request (i.e., a source virtual processor receives a data access request, a metadata virtual processor maintains the metadata for the data that is the subject of the data access request, and the data virtual processor is responsible for accessing the subject data), orchestration is performed among the different virtual processors to process the given data access request.

However, data that is the subject of a read or write request can be relatively large (the subject data can include megabytes, gigabytes, terabytes, etc., of data), so transferring the subject data between computing nodes as part of the orchestration (sometimes referred to as “east-west” communications of data) can consume substantial resources of the storage arrangement. The resources consumed can include communication resources, processing resources, and storage resources.

In accordance with some implementations of the present disclosure, in a storage arrangement including a cluster of computing nodes that execute virtual processors for managing access of respective data partitions, a data access request is processed by orchestrating interactions between at least two virtual processors, where the orchestration may include exchanging metadata for the subject data without exchanging the subject data itself between the virtual processors. In other words, to process the data access request, exchanges of the subject data between computing nodes can be avoided or made less likely. For a write request (e.g., a put request to add the payload of a data object to a shared storage system), a source virtual processor (at the computing node that received the write request) interacts with a metadata virtual processor to obtain metadata that can be used by the source virtual processor to update an intent structure (that stores entries indicating intents to write data) and to complete the data write. The intent structure can be used for fault recovery in case of a fault condition that prevents a completion of the data write in response to the write request.

For a read request (e.g., a get request to retrieve a data object from the shared storage system), a source virtual processor can interact with both a metadata virtual processor and a data virtual processor to read the requested data.

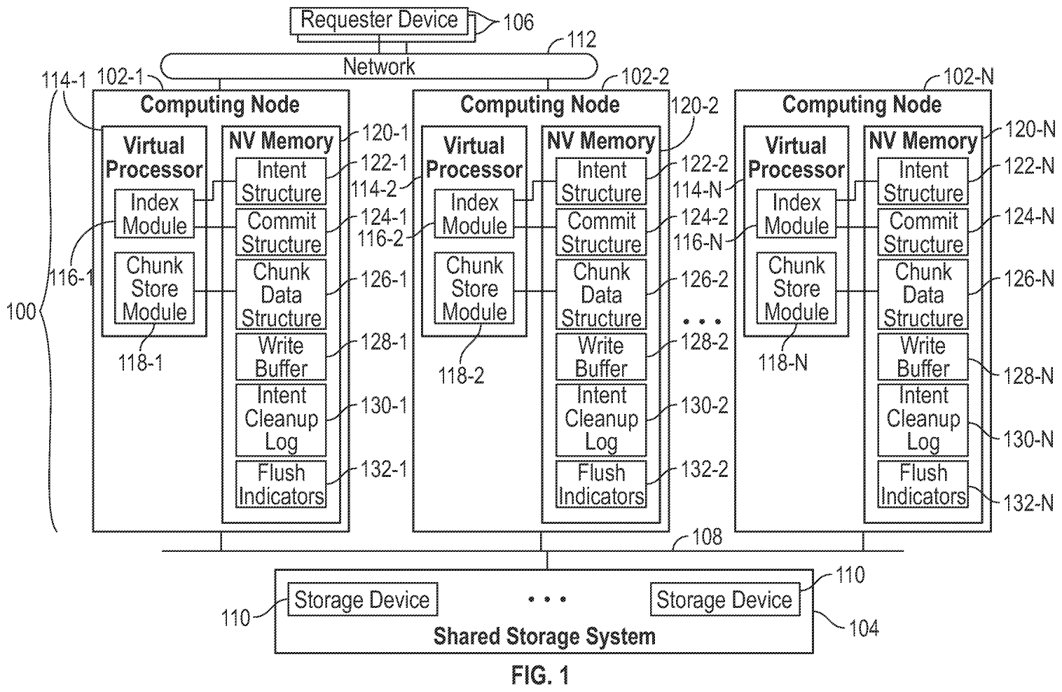

FIG. 1 is a block diagram of an example arrangement that includes a cluster 100 of computing nodes 102-1, 102-2, . . . , 102-N (N≥2). A “computing node” can refer to a physical node that includes a processing resource as well as other resources (e.g., communication resources and memory resources) that can perform various tasks. A “processing resource” can include one or more hardware processing circuits which can include any or some combination of a microprocessor, a core of a multi-core microprocessor, a microcontroller, a programmable integrated circuit, a programmable gate array, or another hardware processing circuit. A “communication resource” can include a communication interface (including communication hardware such as a transceiver and any related machine-readable instructions). A “memory resource” can include a memory implemented with a collection of one or more memory devices.

The cluster 100 of computing nodes is able to manage the access of data stored in a shared storage system 104 in response to data access requests received from requester devices 106. As used here, a “requester device” can refer to any electronic device that is able to send a request to access data (read data or write data). Examples of electronic devices include any or some combination of the following: desktop computers, notebook computers, tablet computers, server computers, game appliances, Internet-of-Things (IoT) devices, vehicles, household appliances, and so forth.

The shared storage system 104 is accessible by any of the computing nodes 102-1 to 102-N over a communication link 108 between the cluster 100 of computing nodes and the shared storage system 104. The shared storage system 104 is implemented using a collection of storage devices 110. As used here, a “collection” of items can refer to a single item or to multiple items. Thus, the collection of storage devices 110 can include a single storage device or multiple storage devices. Examples of storage devices can include any or some combination of the following: disk-based storage devices, solid state drives, and so forth.

The requester devices 106 can send data access requests to any of the computing nodes 102-1 to 102-N over a network 112. Examples of the network 112 can include any or some combination of the following: a storage area network (SAN), a local area network (LAN), a wide area network (WAN), and so forth.

Each computing node executes a collection of virtual processors (a single virtual processor or multiple virtual processors). A virtual processor is executed by a processing resource of a computing node.

In the example of FIG. 1, the computing node 102-1 includes a virtual processor 114-1, the computing node 102-2 includes a virtual processor 114-2, and the computing node 102-N includes a virtual processor 114-N. Although just one virtual processor is depicted in each computing node of FIG. 1, note that each computing node may include more than one virtual processor. Communications among the virtual processors 114-1, 114-2, and 114-N can occur over a communication link between the virtual processors, such as an inter-process link.

Virtual processors can also be migrated between computing nodes. For example, to achieve load balancing, a first virtual processor may be migrated from a current computing node to a destination computing node. Once migrated, the first virtual processor executes at the destination computing node.

Each virtual processor 114-1 can include a respective index module and chunkstore module. For example, the virtual processor 114-1 includes an index module 116-1 and a chunkstore module 118-1, the virtual processor 114-2 includes an index module 116-2 and a chunkstore module 118-2, and the virtual processor 114-N includes an index module 116-N and a chunkstore module 118-N. In further examples, a virtual processor can include either an index module or a chunkstore module (i.e., the virtual processor does not have to include both the index module and the chunkstore module). In such further examples, each of the index modules and chunkstore modules may be considered virtual processors to enable independent management of metadata and data.

A “module” can refer to a portion of a larger structure, such as a virtual processor. For example, a module in a virtual processor can include a subset of machine-readable instructions that make up the virtual processor. An index module is a portion of a virtual processor that is responsible for maintaining various index metadata (discussed further below) associated with data objects to be stored to the shared storage system 104. A chunkstore module is a portion of a virtual processor that maintains storage location metadata representing storage locations of chunks (also referred to as “data chunks”) of data objects in the shared storage system 104. Although FIG. 1 depicts the index modules and chunkstore modules as being separate modules, in other examples, an index module can be integrated with a chunkstore module into one module in a respective virtual processor.

A data object can be divided into a collection of data chunks (a single data chunk or multiple data chunks). Each data chunk has a specified size (a static size or a size that can dynamically change). The storage locations of the data chunks are storage locations in the shared storage system 104. The storage location metadata maintained by the chunkstore module can include any or some combination of the following: an offset, a storage address, a block number, and so forth.

The metadata maintained by the index modules and chunkstore modules can be contained in respective metadata structures. As used here, a “metadata structure” can refer to any container of metadata, which can be in the form of file(s), table(s), tree(s), and so forth. Metadata structures associated with an index module can include an intent structure and a commit structure, while a metadata structure associated with the chunkstore module can include a chunk data structure.

In other examples, information of the intent structure and the commit structure may be integrated into one structure. Additionally, there may be other metadata structures associated with the index module and/or chunkstore module.

The metadata stored in an intent structure and a commit structure that are associated with an index module is referred to as “index metadata.” The index metadata includes write intent metadata maintained by a source virtual processor when handling write requests or when recovering from an anomaly in a corresponding computing node. An anomaly can include a crash in a computing node, such as due to a fault in hardware or machine-readable instructions, a loss of communication, a data error, or any other cause. Another anomaly can include a loss of connection between a computing node and a requester device that submitted a request to access data. The index metadata further includes commit metadata maintained by a metadata virtual processor during write operations and read operations. The index metadata is also used when a source virtual processor is recovering from an anomaly at a corresponding computing node.

The write intent metadata contained in an intent structure indicates that a respective source virtual processor is in the process of handling a write request to write data to the shared storage system 104 (the write operation in response to the write request is in-progress). The intent structure is updated by the source virtual processor.

The commit metadata contained in a commit structure indicates whether a write of a subject data object is in progress (e.g., at a virtual processor that is assigned to handle the write) or a write of the subject data object is no longer in progress (i.e., a write of the subject data object is complete). Note that a write of the subject data object is complete if the subject data object has been written to either a write buffer (discussed further below) or the shared storage system 104. The commit structure is updated by a metadata virtual processor (i.e., the virtual processor that owns the data object metadata for the subject data object). The data object metadata can include: a list of chunk identifiers (IDs) that identify chunks of a data object, and a virtual processor ID that identifies a data virtual processor that owns the chunks identified by the list of chunk IDs. The list of chunk IDs can include a single chunk ID or multiple chunk IDs. The data object metadata can further include a version ID that represents a version of a data object. As a data object is modified by write request(s), corresponding different versions of the data object are created (and identified by respective version IDs).

As used here, an “ID” can refer to any information (e.g., a name, a string, etc.) that can be used to distinguish one item from another item (e.g., distinguish between data chunks, or distinguish between data objects, or distinguish between versions of a data object, or distinguish between virtual processors, and so forth).

The chunk data structure stores storage location metadata representing storage locations. The chunk data structure is updated by a data virtual processor (i.e., the virtual processor that manages reads and writes of data).

The metadata structures can be stored in a non-volatile (NV) memory of a corresponding computing node. An NV memory is a memory that can persistently store data, such that data stored in the NV memory is not lost when power is removed from the NV memory or from a computing node in which the NV memory is located. An NV memory can include a collection of NV memory devices (a single NV memory device or multiple NV memory devices), such as flash memory devices and/or other types of NV memory devices.

The computing node 102-1 includes an NV memory 120-1 that stores an intent structure 122-1, a commit structure 124-1, and a chunk data structure 126-1. The intent structure 122-1 and the commit structure 124-1 are associated with the index module 116-1 (i.e., the index module 116-1 is able to access information in the intent structure 122-1 and the commit structure 124-1). The chunk data structure 126-1 is associated with the chunkstore module 118-1 (i.e., the chunkstore module 118-1 is able to access information in the chunk data structure 126-1).

The index module 116-2 in the virtual processor 114-2 is associated with an intent structure 122-2 and a commit structure 124-2 stored in an NV memory 120-2 of the computing node 102-2, and the chunkstore module 118-2 in the virtual processor 114-2 is associated with a chunk data structure 126-2 stored in the NV memory 120-2. Similarly, the index module 116-N in the virtual processor 114-N is associated with an intent structure 122-N and a commit structure 124-N stored in an NV memory 120-N of the computing node 102-N, and the chunkstore module 118-N is associated with a chunk data structure 126-N stored in the NV memory 120-N.

In some examples, a virtual processor is associated with a write buffer that stores write data during write operations to the shared storage system 104. When the write request is received by the virtual processor, the corresponding write data is written to the write buffer. The write buffer is stored in an NV memory so that data objects in the write buffer are not lost when power is removed from the NV memory or a computing node in which the NV memory is located. At a later time, the data objects in the write buffer can be flushed (written) to the shared storage system 104. A write operation for a given write request can be considered complete when the respective subject data is written to the write buffer.

In FIG. 1, the virtual processor 114-1 is associated with a write buffer 128-1 stored in the NV memory 120-1, the virtual processor 114-2 is associated with a write buffer 128-2 stored in the NV memory 120-2, and the virtual processor 114-N is associated with a write buffer 128-N stored in the NV memory 120-N.

Each virtual processor is also associated with an intent cleanup log that is used during an anomaly recovery. A “log” can refer to any data structure to store data, such as a file, a text document, a table, and so forth. The virtual processor 114-1 is associated with an intent cleanup log 130-1 stored in the NV memory 120-1, the virtual processor 114-2 is associated with an intent cleanup log 130-2 stored in the NV memory 120-2, and virtual processor 114-N is associated with an intent cleanup log 130-N stored in the NV memory 120-N.

Each commit structure 124-i (i=1 to N) can include information as indicated in Table 1 below. The commit structure 124-i includes information of data objects that are in the process of being committed or that have been committed. A data object that is the subject of a write request is in the process of being committed when a write operation to write the data object has been started but is not yet at a state where the subject data object is persistently stored. The subject data object is “committed” if the write operation initiated by the write request has persistently stored the subject data object such that the subject data object is available for later retrieval. For example, the subject data object may be persistently stored in a write buffer (e.g., 130-i) or persistently stored in the shared storage system 104.

TABLE 1

Commit Structure (124-i)
Commit Structure ID = f1(Bucket ID, Partition ID)
Key = f2(Object ID, Version ID)
Value = Chunk List

The commit structure 124-i is identified by a Commit Structure ID, which is a value produced by f1 (Bucket ID, Partition ID), where “f1( )” represents a function applied on the content included in the parenthetical. A “function” can be a concatenation, a hash function, or any other type of function. In the example of Table 1, the Commit Structure ID is based on the function, f1( ), applied on a Bucket ID and a Partition ID.

In some examples, data can be included in buckets, where a bucket can refer to any type of container that includes a collection of data objects. Each bucket is identified by a Bucket ID. A specific example of a bucket is an S3 bucket in an Amazon cloud storage. In other examples, other types of buckets can be employed. Although reference is made to buckets in some examples, in further examples, data is not arranged in buckets.

Data processing (write processing and/or read processing) to be performed by the cluster 100 of computing nodes can be divided into multiple data processing partitions (or more simply, “partitions”). Each virtual processor is responsible for performing the data processing of one or more partitions. In an example, there are M (M≥2) partitions and P (P≥2) virtual processors. In such an example, each virtual processor of the P virtual processors is responsible for data processing of M/P partitions.

A partition is identified by a Partition ID. In some examples, a Partition ID is based on applying a hash function (e.g., a cryptographic hash function or another type of hash function) on information associated with a data object. The information associated with the data object on which the hash function is applied includes a Bucket ID identifying the bucket of which the data object is part, and an Object ID that identifies the data object. The hash function applied on the information associated with the data object produces a hash value that is the Partition ID.

In some examples, there is one commit structure per bucket partition. If there are M partitions, then for each bucket there would be M commit structures identified by respective Commit Structure IDs.

As listed in Table 1, the commit structure 124-i also includes a key and an associated value (a key-value pair). The key of the key-value pair is produced by f2(Object ID, Version ID), which is a function applied on the Object ID and Version ID of a respective data object. The function, f2( ), applied to produce the key of a key-value pair may be the same as or different from the function, f1( ), used to produce the Commit Structure ID.

Each data object can have one or more versions. When a given data object is initially created, a first version of the given data object is generated. As the given data object is subsequently modified (e.g., overwritten, replaced, etc.), subsequent version(s) of the given data object is (are) generated. Each version of a data object (referred to as a “data object version”) is identified by a Version ID. The key produced by f2(Object ID, Version ID) refers to a corresponding data object version.

The value of the key-value pair is a chunk list that is a list of chunk IDs that identify one or more data chunks that are part of the data object version referred to by the key.

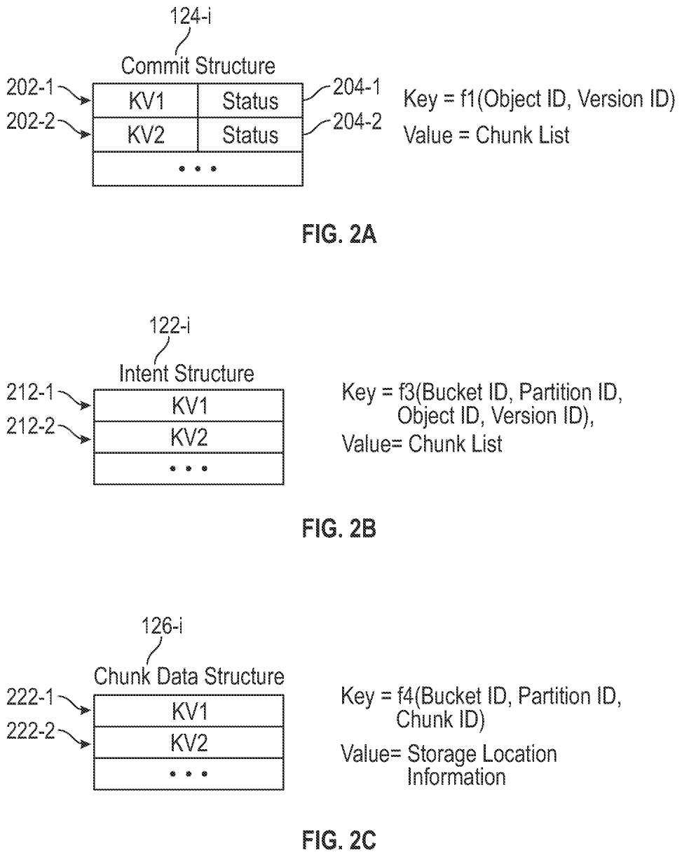

FIG. 2A shows an example of the commit structure 124-i, which includes multiple entries 202-1, 202-2, etc., for respective data object versions. Each entry of the commit structure 202 includes a key-value pair. For example, in FIG. 2A, the entry 202-1 has a key-value pair KV1, the entry 202-2 has a key-value pair KV2, and so forth. The key and value of each key-value pair is defined by Table 1 above.

Each entry of the commit structure 202 also includes a respective status flag. The entry 202-1 has a status flag 204-1, the entry 202-2 has a status flag 204-2, and so forth. The status flag can have a first status flag value to indicate that a data object version identified by the key of the respective key-value pair is in the process of being committed, and a second status flag value (different from the first status flag value) to indicate that the data object version is no longer in the process of being committed (e.g., the data object version has been committed). The status flag set to the first status flag value is referred to as setting an “in-progress” flag for the data object version, and the status flag set to the second status flag value is referred to as clearing the in-progress flag.

Each intent structure 122-i can include information as indicated in Table 2 below. The intent structure 122-i includes information of data objects that are in the process of being committed (i.e., data objects to be committed by a source virtual processor). The intent structure is updated by the source virtual processor during write operations and is used during an anomaly recovery in case an anomaly interrupts write operations such that the write operations are unable to complete.

TABLE 2

Intent Structure (122-i)
Key = f3(Bucket ID, Partition ID, Object ID, Version ID)
Value = Chunk List

In some examples, there is one intent structure per virtual processor. In other words, each virtual processor has its own intent structure. As listed in Table 2, the intent structure 122-i includes a key and an associated value (a key-value pair). The key of the key-value pair is produced by f3(Bucket ID, Partition ID, Object ID, Version ID), which is a function applied on the Bucket ID, Partition ID, Object ID, and Version ID of a respective data object version that is contained in a bucket identified by Bucket ID and which is being processed in a partition identified by Partition ID. The function, f3( ), applied to produce the key of each key-value pair in the intent structure 122-i, may be the same as or different from the functions, f1( ) and f2( ) in Table 1.

The associated value of the key-value pair is a chunk list that is a list of chunk IDs that identify one or more data chunks that are part of the data object version referred to by the key.

FIG. 2B shows an example of the intent structure 122-i, which includes multiple entries 212-1, 212-2, etc., for respective data object versions. Each entry of the intent structure 122-i includes a key-value pair. For example, in FIG. 2B, the entry 212-1 has a key-value pair KV1, the entry 212-2 has a key-value pair KV2, and so forth. The key and value of each key-value pair includes information is defined by Table 2 above.

Each chunk data structure 126-i can include information as indicated in Table 3 below. The chunk data structure 126-i includes storage location metadata regarding storage locations in the shared storage system 104 where data objects are stored.

TABLE 3

Chunk Data Structure (126-i)
Key = f4(Bucket ID, Partition ID, Chunk ID)
Value = Storage Location Information

In some examples, there is one chunk data structure per virtual processor. In other words, each virtual processor has its own chunk data structure.

As listed in Table 3, the chunk data structure 126-i includes a key and an associated value (a key-value pair). The key of the key-value pair is produced by f4(Bucket ID, Partition ID, Chunk ID), which is a function applied on the Bucket ID, Partition ID, and Chunk ID of a respective data object that is contained in a bucket identified by Bucket ID and which is being processed in a partition identified by Partition ID. The function, f4( ), applied to produce the key of each key-value pair in the chunk data structure 126-i, may be the same as or different from the functions, f1( ), f2( ), and f3( ) in Tables 1 and 2.

The value of the key-value pair includes storage location information that specifies a storage location of the data chunk identified by the key in the shared storage system 104.

FIG. 2C shows an example of the chunk data structure 126-i, which includes multiple entries 222-1, 222-2, etc., for respective data objects. Each entry of the chunk data structure 126-i includes a key-value pair. For example, in FIG. 2C, the entry 222-1 has a key-value pair KV1, the entry 222-2 has a key-value pair KV2, and so forth. The key of a key-value pair in the chunk data structure 126-i includes information is defined by Table 3 above. There is one entry per data chunk in the chunk data structure 126-i.

### Write Processing

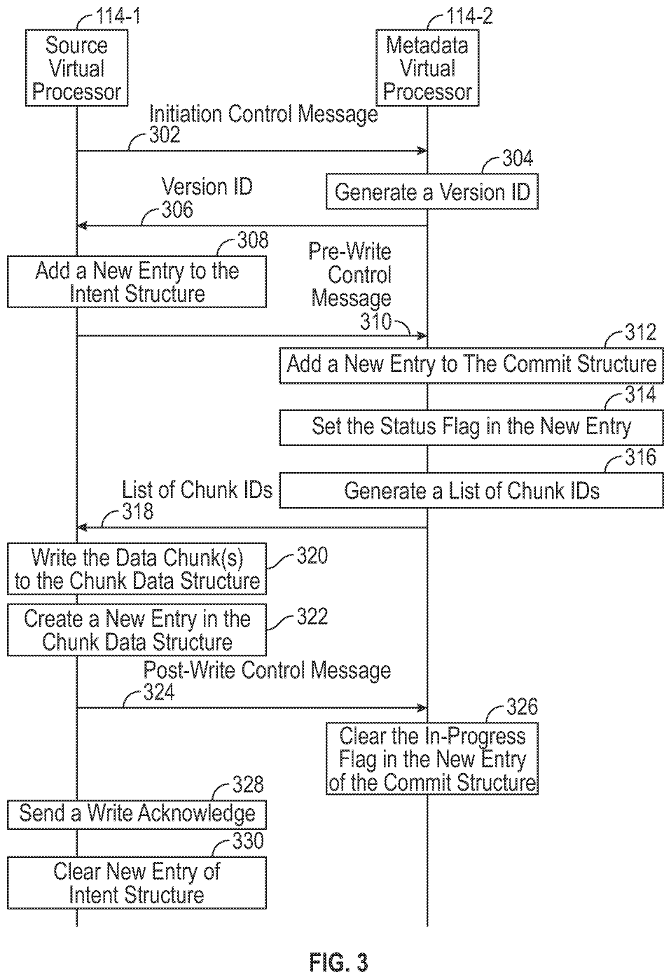

FIG. 3 is a flow diagram illustrating a write operation that is performed in response to an incoming write request, which may be received from a requester device 106 in FIG. 1. Although FIG. 3 depicts a specific order of tasks, in other examples, the tasks may be performed in a different order or in parallel, and/or some of the tasks may be omitted and/or other tasks may be included. In the example, the virtual processor 114-1 is the source virtual processor assigned to handle the incoming write request received by the computing node 102-1 in which the source virtual processor 114-1 is located. The computing node that received the incoming write request is referred to as the “receiving computing node.” In other examples, a different computing node received the incoming write request, and a different source virtual processor is assigned to handle the incoming write request.

In examples where the receiving computing node 102-1 executes multiple virtual processors, the receiving computing node 102-1 selects the source virtual processor 114-1 from the multiple virtual processors of the receiving computing node using a selection process. For example, the selection process may be a random selection process in which the source virtual processor 114-1 is randomly selected from the multiple virtual processors. In another example, the selection process can be based on determining relative loads of the virtual processors in the receiving computing node 102-1, and selecting a virtual processor with the least load to be the source virtual processor 114-1.

In further examples, the source virtual processor 114-1 selected from the multiple virtual processors may be based on which of the virtual processors of the cluster 100 computing nodes is the metadata virtual processor. In the example of FIG. 3, it is assumed that the virtual processor 114-2 is the metadata virtual processor. The different virtual processors of the cluster 100 of computing nodes are assigned respective virtual processor IDs. In the further examples, the selection process can include the receiving computing node making a determination of which virtual processor is the metadata virtual processor for the subject data object of a write request. Based on the identified metadata virtual processor, the receiving computing node 102-1 can select the corresponding virtual processor in the receiving computing node to be the source virtual processor 114-1. The determination of the metadata virtual processor is based on determining the partition for the subject data object, and based on the determined partition, the receiving computing node 102-1 identifies the metadata virtual processor for the partition. A hash function or another type of function can be applied on the virtual processor ID of the metadata virtual processor to produce an output value (e.g., a hash value or another value) that is used to select the source virtual processor 114-1.

In response to the incoming write request, the source virtual processor 114-1 sends (at 302) an initiation control message to the metadata virtual processor 114-2. A “message” can refer to any information that can be exchanged between entities such as virtual processors. A “control message” is a message that is used by one entity to inform another entity of an event or to cause another entity to perform an action. The initiation control message contains the bucket ID, partition ID, and object ID of the subject data object, and contains an indication that a write operation is being initiated by the source virtual processor 114-1.

In response to the initiation control message, the index module 116-2 of the metadata virtual processor 114-2 generates (at 304) a version ID that uniquely identifies a new version of the subject data object (the new version is the version of the subject data object after the write operation is completed). The metadata virtual processor 114-2 sends (at 306) the version ID for the subject data object back to the source virtual processor 114-1. The version ID may be sent in a response message (that is responsive to the initiation control message), for example.

The index module 116-1 of the source virtual processor 114-1 adds (at 308) a new entry to the intent structure 122-1 that is associated with the source virtual processor 114-1. The key of the key-value pair added to the new entry of the intent structure 122-1 is derived by f3(Bucket ID, Partition ID, Object ID, Version ID), where Version ID was provided (at 306) from the metadata virtual processor 114-2 to the source virtual processor 114-1.

At this point, the chunk list for the value of the key-value pair in the new entry is not known. As a result, the value of the key-value pair in the new entry of the intent structure 122-1 may have a null (invalid) or other predetermined value.

The source virtual processor 114-1 sends (at 310) a pre-write control message to the metadata virtual processor 114-2. The pre-write control message contains the Bucket ID, Partition ID, Object ID, and Version ID of the subject data object. The pre-write control message is to indicate to the metadata virtual processor 114-2 that the source virtual processor 114-1 is ready to start the write operation for the incoming write request.

In response to the pre-write control message, the index module 116-2 of the metadata virtual processor 114-2 adds (at 312) a new entry to the commit structure 124-2 that is associated with the metadata virtual processor 114-2. The new entry of the commit structure 124-2 includes a key-value pair that contains the content set forth in Table 1 above. In addition, the index module 116-2 of the metadata virtual processor 114-2 sets (at 314) the status flag in the new entry of the commit structure 124-2 to the first status flag value (which sets the in-progress flag in the new entry for the subject data object).

The index module 116-2 of the metadata virtual processor 114-2 also generates (at 316) a list of chunk IDs that identifies one or more data chunks for the subject data object. The chunk ID(s) generated depend(s) on the size of the subject data object—the size of the subject data object determines how many data chunks are to be divided from the subject data object. The metadata virtual processor 114-2 sends (at 318) the list of chunk IDs to the source virtual processor 114-1.

In response to receiving the list of chunk IDs from the metadata virtual processor 114-2, the chunkstore module 118-1 of the source virtual processor 114-1 writes (at 320) the data chunk(s) of the subject data object using the chunk ID(s) included in the list of chunk IDs. The chunkstore module 118-1 of the source virtual processor 114-1 can write the data chunk(s) to the write buffer (128-1) associated with the source virtual processor 114-1 and/or to the shared storage system 104.

As part of writing the data chunk(s), the chunkstore module 118-1 also creates (at 322) a new entry in the chunk data structure 126-1 associated with the source virtual processor 114-1. The new entry in the chunk data structure 126-1 includes a key defined by Table 3 above and a value that includes information of the storage location(s) of the data chunk(s) being written.

After writing the data chunk(s), the source virtual processor 114-1 sends (at 324) a post-write control message to the metadata virtual processor 114-2. The post-write control message contains the Bucket ID, Partition ID, Object ID, and Version ID associated with the subject data object. The post-write control message indicates that the write of the data chunk(s) of the subject data object has completed.

In response to receiving the post-write control message, the index module 118-2 of the metadata virtual processor 114-2 clears (at 326) the in-progress flag from the new entry of the commit structure 124-2, by setting the status flag to the second status flag value.

The source virtual processor 114-1 sends (at 328) a write acknowledge to the requester device that submitted the incoming write request. The write acknowledge indicates to the requester device that the write for the incoming write request has completed. Note that the subject data object of the incoming write request may be in the write buffer 128-1 and/or in the shared storage system 104. In some examples, the chunkstore module 118-1 may track whether the subject data object is in the write buffer 128-1 or has been flushed to the shared storage system 104. This may be tracked using flush indicators 132-1 (stored in the NV memory 120-1, for example) associated with respective data objects (e.g., the flush indicators 132-1 may be mapped to the respective data objects using mapping information. A flush indicator may have a first value to indicate that a corresponding data object is in the write buffer 128-1 and has not yet been flushed to the shared storage system 104, and the flush indicator may have a second value to indicate that the corresponding data object has been flushed to the shared storage system 104. The computing nodes 102-2 and 102-N similarly include corresponding flush indicators 132-2 and 132-N stored in respective NV memories 120-2 and 120-N.

Since the source virtual processor 114-1 is the virtual processor that performed the write for the incoming write request, the source virtual processor 114-1 is also considered to be the data virtual processor for the data of the subject data object written in response to the incoming write request. In some examples, the source virtual processor 114-1 can send, to the metadata virtual processor 114-2, information indicating that the virtual processor 114-1 is the owner virtual processor of the subject data object. The metadata virtual processor 114-2 can record in the commit structure 124-2 or in another structure information identifying the virtual processor 114-1 (using a virtual processor identifier)) as being the data virtual processor of the subject data object.

Additionally, the index module 118-1 of the source virtual processor 114-1 clears (at 330) the new entry of the intent structure 122-1, such as by removing the new entry from the intent structure 122-1. Once an entry is removed, the intent structure 122-1 no longer indicates that a corresponding write operation is still in-progress.

As depicted in FIG. 3, the source virtual processor 114-1 is able to process the incoming write request by performing a write operation that does not involve exchanging the subject data object for the incoming write request between virtual processors. Instead, the source virtual processor 114-1 can perform the write operation by obtaining metadata for the subject data object of the incoming write request. The size of the metadata is typically much less than the size of the subject data object.

### Read Processing

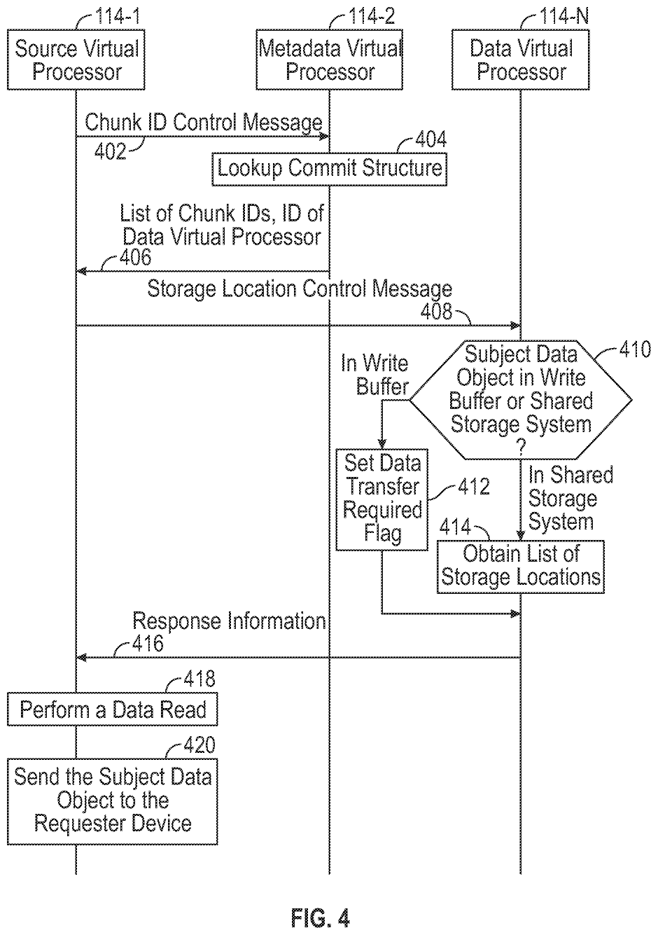

FIG. 4 is a flow diagram of a process of handling an incoming read request from a requester device. Although FIG. 4 depicts a specific order of tasks, in other examples, the tasks may be performed in a different order or in parallel, and/or some of the tasks may be omitted and/or other tasks may be included.

FIG. 4 assumes an example in which the computing node 102-1 is the receiving computing node, the virtual processor 114-1 is the source virtual processor, the virtual processor 114-2 is the metadata virtual processor, and the virtual processor 114-N is the data virtual processor that owns the subject data object of the incoming read request.

The receiving computing node 102-1 can select a virtual processor (from multiple virtual processors assuming there are multiple virtual processors in the receiving computing node) using a selection process similar to the selection process used for processing an incoming write request as depicted in FIG. 3.

In response to the incoming read request, the source virtual processor 114-1 sends (at 402) a chunk ID control message to the metadata virtual processor 114-2, to request a list of chunk IDs that identify data chunk(s) containing data of the subject data object that is to be read. The chunk ID control message includes the Object ID and Version ID of the subject data object. The Object ID and the Version ID may have been included in the incoming read request.

In response to the chunk ID control message, the index module 118-2 of the metadata virtual processor 114-2 performs a lookup (at 404) of the commit structure 124-2 to find a corresponding entry in the commit structure 124-2. The Object ID and Version ID of the subject data object included in the chunk ID control message are used to derive a key (e.g., based on f2(Object ID, Version ID)) that is matched to a key in the commit structure 124. If a match occurs, the entry of the commit structure 124-2 containing the matching key is the “matched entry.”

The matched entry found by the lookup includes the list of chunk IDs for the data chunk(s) of the subject data object. The metadata virtual processor 114-2 sends (at 406), to the source virtual processor 114-1, the list of chunk IDs and a virtual processor ID that identifies the data virtual processor 114-N. In response to receiving the list of chunk IDs, the source virtual processor 114-1 sends (at 408) a storage location control message to the data virtual processor 114-N that requests the storage locations of the subject data object. The control message sent (at 408) contains the list of chunk IDs.

In response to receiving the storage location control message, the chunkstore module 118-N of the data virtual processor 114-N determines (at 410) whether the subject data object is in the write buffer 128-N or has been flushed to the shared storage system 104. For example, this can be based on the flush indicators 132-N in the NV memory 120-N.

If the chunkstore module 118-N of the data virtual processor 114-N determines (based on a respective flush indicator 132-N) that the subject data object is in the write buffer 128-N (not yet flushed), the chunkstore module 118-N of the data virtual processor 114-N sets (at 412) a Data Transfer Required flag to indicate that a data transfer has to be performed before the subject data object can be read. Setting the Data Transfer Required flag can refer to setting the Data Transfer Required flag to a specified value.

On the other hand, if the chunkstore module 118-N of the data virtual processor 114-N determines that the data of the subject data object has been flushed to the shared storage system 104, then the chunkstore module 118-N obtains (at 414) the list of storage locations by performing a lookup of the data chunk structure 126-N associated with the data virtual processor 114-N. The lookup includes applying f4(Bucket ID, Partition ID, Chunk ID) to obtain the key for each chunk ID in the list of chunk IDs received from the metadata virtual processor 114-2. Matching entries in the chunk data structure 126-N include respective key-value pairs that contain information of the storage locations for the corresponding data chunks.

The data virtual processor 114-N sends (at 416) sends response information (which is responsive to the storage location control message) to the source virtual processor 114-1. The response information can include either the Data Transfer Required flag or the list of storage locations, depending upon whether or not the subject data object has been flushed.

In response to the response information, the source virtual processor 114-1 performs (at 418) a data read to retrieve the subject data object. If the response information from the data virtual processor 114-N includes the list of storage locations, then the chunkstore module 118-1 of the source virtual processor 114-1 can read the data chunks from the storage locations of the shared storage system 104.

On the other hand, if the Data Transfer Required flag was received from the data virtual processor 114-N (or if an error occurred when reading the data chunks from the storage locations of the shared storage system 104), the source virtual processor 114-1 establishes a data session with the data virtual processor 114-N, and the source virtual processor 114-1 retrieves the data chunks of the subject data object from the data virtual processor 114-N in the data session.

In the above example, if the subject data object is already in the shared storage system 104, the source virtual processor 114-1 is able to retrieve subject data object from the shared storage system 104 without having to exchange the subject data object with the data virtual processor 114-N.

Upon receiving the subject data object (either directly from the shared storage system 104 or indirectly via the data virtual processor 114-N), the source virtual processor 114-1 sends (at 420) the subject data object to the requester device that submitted the incoming read request.

### Anomaly Recovery

During one or more write operations initiated in response to one or more incoming write requests, an anomaly can occur that can prevent the write operation(s) from completing at a given source virtual processor 114-i. As examples, the anomaly can include a crash caused by a hardware fault at the computing node 102-i, a fault of machine-readable instructions at the computing node 102-i (such as a fault of the source virtual processor 114-i or another program), a loss of communication experienced by the source virtual processor 114-i (e.g., the source virtual processor 114-i is unable to communicate with a metadata virtual processor), or due to any other cause. When the crash occurs, some entries of the intent structure 122-i associated with the source virtual processor 114-i may not have been cleared. Any uncleared entry in the intent structure 122-i represents a data object associated with a write operation that has not yet completed due to the crash.

Another anomaly involves the loss of a connection to a requester device that submitted an incoming write request. The loss of the connection may be due to a timeout or another cause.

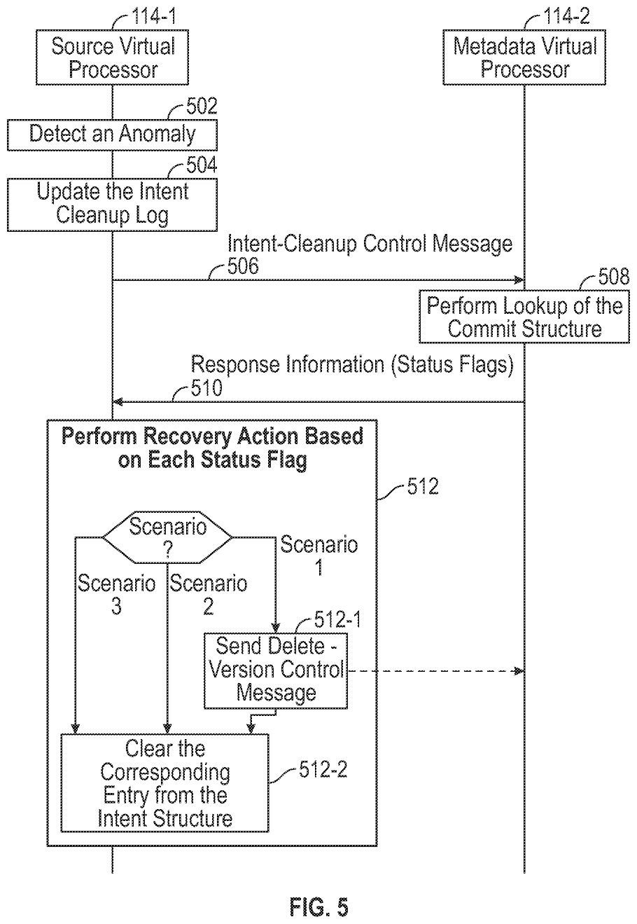

FIG. 5 is a flow diagram of an anomaly recovery process. Although FIG. 5 depicts a specific order of tasks, in other examples, the tasks may be performed in a different order or in parallel, and/or some of the tasks may be omitted and/or other tasks may be included. In the example, it is assumed that the source virtual processor 114-1 experienced the crash.

The source virtual processor 114-1 can detect (at 502) the anomaly in a number of different ways. If the anomaly is a loss of connection to a requester device, the source virtual processor 114-1 can detect the loss of connection based on a timeout in communications with the requester device, for example. As an example, for a write request, the loss of connection may occur during a transfer of a write data from the requester device to the receiving computing node. If the anomaly is a crash, when the source virtual processor 114-1 starts (e.g., due to a reset of the computing node 102-1 or due to the source virtual processor 114-1 restarting), the source virtual processor 114-1 can detect an indication that a crash has occurred. The indication can be in the form of a crash indicator (e.g., a flag or another value) written to the NV memory 120-1 of the computing node 102-1.

In response to detecting the anomaly, the source virtual processor 114-1 updates (at 504) the intent cleanup log 130-1 with information corresponding to data objects that are the subject of incomplete write operations (incomplete because of the anomaly). In some examples, opportunistic batching can be performed when updating the intent cleanup log 130-1 by including in the intent cleanup log 130-1 all information relating to data objects (that are the subject of incomplete write operations) mapped to the same metadata virtual processor 114-2 (i.e., the same metadata virtual processor 114-2 owns the metadata for the data objects).

The updating of the intent cleanup log 130-1 includes adding intent entries to the intent cleanup log 130-1. Each intent entry added to the intent cleanup log 130-1 includes the Object ID and the Version ID of the data object that is the subject of an incomplete write operation interrupted by an anomaly.

If a crash occurred, the source virtual processor 114-1 can gather information from the non-cleared entries of the intent structure 122-1 into the intent cleanup log 130-1. A “non-cleared” entry of the intent structure 122-1 is one where the entry has not yet been removed, such that the entry indicates that a write operation is still in-progress for a corresponding data object. Note that at any given point in time, the source virtual processor 114-1 may be handling multiple write requests such that there may potentially be multiple non-cleared entries in the intent structure 122-1.

If a loss of connection with the requester device that submitted a write request occurred, then the source virtual processor 114-1 updates the intent cleanup log 130-1 by adding the entry in the intent structure 122-1 corresponding to the write request to the intent cleanup log 130-1. The information added to the intent cleanup log 130-1 can include the key-value pair(s) of the respective entry (or entries) of the intent structure 122-1.

In response to detecting the anomaly, the source virtual processor 114-1 sends (at 506) an intent-cleanup control message to the metadata virtual processor 114-2. The intent-cleanup control message can include the Object ID and Version ID of each intent entry in the intent cleanup log 130-1. If there are multiple intent entries in the intent cleanup log 130-1, the intent-cleanup control message includes multiple Object ID, Version ID pairs that correspond to the multiple intent entries. The multiple Object ID, Version ID pairs represent respective data object versions.

In response to the intent-cleanup control message, the metadata virtual processor 114-2 performs a lookup (at 508) of the commit structure 124-2. A key is derived from each Object ID and Version ID (by applying f1 (Object ID, Version ID) in the intent-cleanup control message and matched to the entries in the commit structure 124-2. For each matching entry in the commit structure 124-2, the corresponding status flag (e.g., 204-1, 204-2, etc. in FIG. 2A) is retrieved.

The metadata virtual processor 114-2 sends (at 510), to the source virtual processor 114-1, response information that is responsive to the intent-cleanup control message. The response information includes the status flag for each of the Object ID, Version ID pairs included in the intent-cleanup control message.

The source virtual processor 114-1 can perform (at 512) respective recovery actions under different scenarios. In scenario 1, a status flag for a data object version (represented by an Object ID, Version ID pair) indicates that the write of the data object version is in-progress. Scenario 1 may occur if the anomaly happened after task 314 in FIG. 3 (when the status flag is set in a new entry of the commit structure) but before task 326 in FIG. 3 (when the status flag is cleared in the new entry of the commit structure). In scenario 1, the source virtual processor 114-1 sends (at 512-1) a delete-version control message to the metadata virtual processor 114-2 to cause the metadata virtual processor 114-2 to remove the corresponding entry from the commit structure 124-2. The delete-version control message includes the Object ID, Version ID pair of the data object version whose metadata to be deleted. The entry removed from the commit structure 124-2 in response to the delete-version control message is the entry that contains the key corresponding to the Object ID, Version ID pair. In response to the delete-version control message, the metadata virtual processor 114-2 can also send a control message to the data virtual processor to delete the corresponding data chunks to free up storage space. The source virtual processor 114-1 also clears (at 512-2) the corresponding entry (the entry corresponding to the Object ID, Version ID pair) from the intent structure 122-1.

In scenario 2, a status flag for a data object version (represented by an Object ID, Version ID pair) indicates that the write of the data object version is not in-progress. Scenario 2 may occur if the anomaly happened after task 326 in FIG. 3 but before task 330 in FIG. 3 (when the new entry of the intent structure is cleared). In this second scenario, the source virtual processor 114-1 clears (at 512-2) the corresponding entry (the entry corresponding to the Object ID, Version ID pair) from the intent structure 122-1.

In scenario 3, the metadata virtual processor 114-2 responded with an object not found indication, which indicates that no entry for the data object version represented by an Object ID, Version ID pair exists in the commit structure 124-2. The third scenario may occur if an entry for the Object ID, Version ID pair has not yet been added to the commit structure 124-2 in response to an incoming write request. Scenario 3 may also occur if the anomaly happened after task 326 in FIG. 3 (the in-progress flag of the new entry of the commit structure was cleared) but before task 328 in FIG. 3 (the write acknowledge was sent to the requester device). The requester device may send a request to delete the data object version since the requester device did not receive the write acknowledge. In the third scenario, the source virtual processor 114-1 clears (at 512-2) the corresponding entry (the entry corresponding to the Object ID, Version ID pair) from the intent structure 122-1.

### Problematic Control Messages

Anomalies may cause issues with control messages. In some cases, control messages can become stale. In other cases, there may be duplicate control messages. Stale or duplicate control messages are referred to as “problematic” control messages. Three example cases of problematic control messages are discussed below.

In a first case, a stale control message may arise when a source virtual processor initially sends a control message (control message 1) to a metadata virtual processor, but the source virtual processor crashed before the source virtual processor receives a response for control message 1 from the metadata virtual processor. The metadata virtual processor has not yet processed control message 1. When the source virtual processor restarts, the source virtual processor may send another control message (control message 2) to the metadata virtual processor. Control message 2 renders control message 1 (sent before the crash and received at the metadata virtual processor) stale at the metadata virtual processor. A stale control message can linger at the metadata virtual processor, and the stale control message may be processed at the metadata virtual processor after control message 2 has been issued, which may lead to an inconsistent state.

An example of the first case is as follows. The source virtual processor sends a post-write control message, which is received by the metadata virtual processor (e.g., 324 in FIG. 3). The source virtual processor then crashes. When the source virtual processor restarts, the source virtual processor sends a delete-version control message to the metadata virtual processor (e.g., 512-1 in FIG. 5). In this example, the delete-version control message is a current control message to be processed by the metadata virtual processor, while the post-write control message is a stale control message at the metadata virtual processor.

In a second case, a stale control message may arise when a source virtual processor initially sends a control message (control message 1) to a metadata virtual processor, but after control message 1 is sent, the communication link between the source and metadata virtual processors drops (neither the source or metadata virtual processor crashed in this second case). When the communication link is re-established and the source virtual processor sends another control message (control message 2), the older message 1 (stale control message) may linger at the metadata virtual processor, and if processed at the metadata virtual processor may lead to an inconsistent state.

An example of the second case is as follows. The source virtual processor sends a first pre-write control message, which is received by the metadata virtual processor. The communication link between the source and metadata virtual processors then drops. The source virtual processor re-establishes the communication link with the metadata virtual processor, and the source virtual processor then sends a second pre-write control message to the metadata virtual processor. The second pre-write control message is processed at the metadata virtual processor (e.g., resulting in tasks 312, 314, 316, and 318 in FIG. 3). Note that at this point the first pre-write control message may not yet be processed (because there is no ordering guarantee regarding control message execution). Subsequently, the source virtual processor clears an entry from the intent structure (e.g., 330 in FIG. 3). At this point, the first pre-write control message is a stale control message.

In a third case, duplicate control messages may arise if the source virtual processor sends a control message (control message 1), but the source virtual processor does not receive a response despite control message 1 having been processed at the metadata virtual processor. The source virtual processor may send the same control message again.

An example of the third case is as follows. The source virtual processor sends a post-write control message (post-write control message 1), which is received by the metadata virtual processor. The metadata virtual processor is then migrated from a current computing node to a destination computing node. The source virtual processor re-connects with the metadata virtual processor after the migration, and the source virtual processor resends the post-write control message (post-write control message 2). The source virtual processor then crashes. After restarting, the source virtual processor sends a delete-version control message to the metadata virtual processor (e.g., 512-1 in FIG. 5). At this point, the delete-version control message is a current control message, and post-write control message 2 is a duplicate of post-write control message 1 and is also stale.

To address the foregoing problematic control messages, virtual processors in the cluster 100 of computing nodes can implement a barrier to prevent the processing of older control messages that may have been replaced by new control messages in the various cases noted above. An older control message can refer to a control message issued prior to a crash of a virtual processor or a loss of a communication link between virtual processors.

The barrier to prevent processing of older control messages can be implemented by assigning generation indicators to control messages. A generation indicator represents a respective round of control messages issued by a virtual processor. For example, a first generation indicator can represent a first round during which a virtual processor can issue a collection of control messages, e.g., prior to an anomaly (e.g., crash or loss of communication). A second generation indicator can represent a second round during which a virtual processor can issue a collection of control messages, e.g., after recovering from the anomaly. The generation indicators may be in the form of generation identifiers that can be incremented or decremented with successive rounds of control messages issued by a virtual processor.

A generation indicator can be associated with a control message to indicate which round the control message is part of. The association of the generation indicator with the control message can include including the generation indicator in the control message or maintaining association information that maps the control message to the generation indicator.

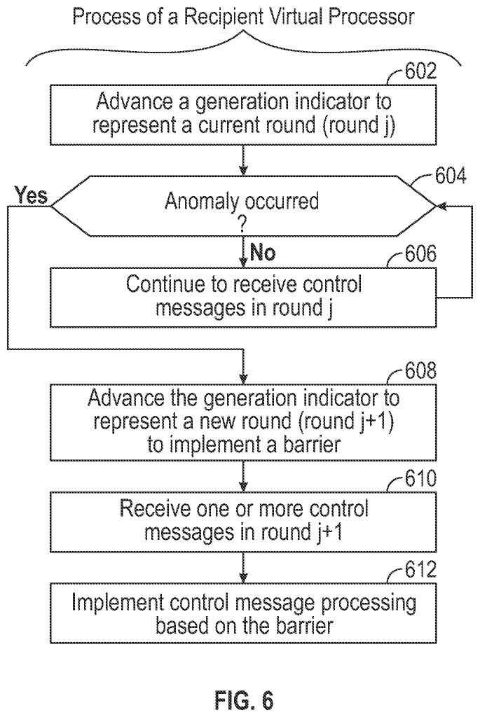

In accordance with some examples of the present disclosure, as shown in FIG. 6, a recipient virtual processor (which is a virtual processor such as a metadata virtual processor that has received control messages from a sending virtual processor such as a source virtual processor) advances (at 602) a generation indicator to represent a current round (round j) in which one or more control messages are to be received by the recipient virtual processor. Advancing the generation indicator can refer to incrementing or decrementing the generation indicator.

The recipient virtual processor determines (at 604) if an anomaly has occurred, such as the sending virtual processor crashing or the communication link to the sending virtual processor dropping. If no anomaly has occurred, the recipient virtual processor continues to receive (at 606) control message(s) in round j.

In response to determining (at 604) that an anomaly has occurred, the recipient virtual processor advances (at 608) the generation indicator (e.g., increments j) to represent a new round (round j+1, which is after round j). The recipient virtual processor receives (at 610) one or more control messages in round j+1. Advancing the generation indicator from j to j+1 implements a barrier with respect to processing of control messages by the recipient virtual processor. The recipient virtual processor implements (at 612) control message processing based on the barrier.

In an example, the barrier prevents the recipient virtual processor that has received one or more control messages in round j+1 from processing any control messages in round j+1 until all control messages in prior round(s) (round j or earlier) have been aborted. Aborting a control message can refer to deleting the control message or otherwise indicating that the control message is not to be executed. In another example, the barrier prevents the recipient virtual processor from executing control messages in any prior round(s), which are round(s) represented by generation indicators prior to a current generation indicator.

### Further Examples

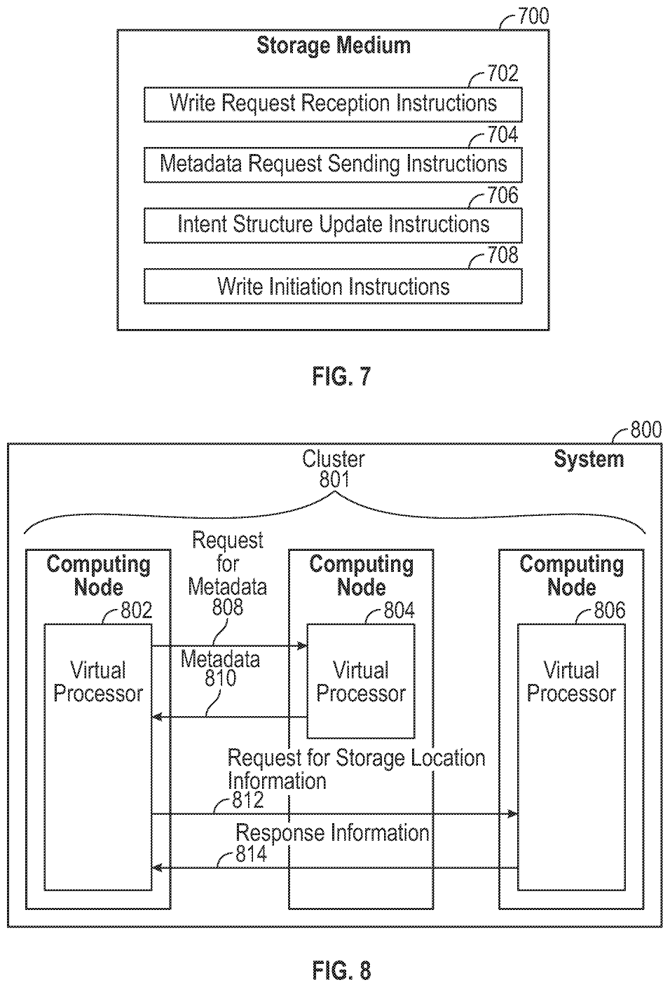

FIG. 7 is a block diagram of a non-transitory machine-readable or computer-readable storage medium 700 storing machine-readable instructions that upon execution cause a processing system to perform various tasks. The processing system can include the cluster 100 of computing nodes of FIG. 1.

The machine-readable instructions include write request reception instructions 702 to receive, at a first computing node, a write request, where the first computing node is part of a collection of multiple computing nodes (e.g., the cluster 100 of computing nodes). A plurality of virtual processors are executable in the multiple computing nodes to manage access of data in a shared storage system (e.g., 104 in FIG. 1). The write request may be received by the first computing node from a requester device (e.g., 106 in FIG. 1).

The machine-readable instructions include metadata request sending instructions 704 to, in response to the write request, send, from a first virtual processor at the first computing node to a second virtual processor, a request for metadata stored by the second virtual processor. The first virtual processor can be a source virtual processor, and the second virtual processor can be a metadata virtual processor. In some examples, the second virtual processor may be executed in a second computing node separate from the first computing node. The request for metadata can be in the form of a control message, such as an initiation control message (e.g., 302 in FIG. 3) or a pre-write control message (e.g., 310 in FIG. 3).

The machine-readable instructions include intent structure update instructions 706 to update, by the first virtual processor, an intent structure (e.g., any of 122-1 to 122-N in FIG. 1) in an NV memory with information indicating an intent to write data for the write request. For example, the first virtual processor can add a new entry to the intent structure. The new entry corresponds to an identifier of the data and a version of the data.

The machine-readable instructions include write initiation instructions 708 to, in response to the metadata received at the first virtual processor from the second virtual processor, initiate a write of the data to cause storage of the data in the shared storage system. The data can be written to a write buffer (e.g., any of 128-1 to 128-N) to be later flushed to the shared storage system.

In some examples, the write request is to write a data object to the shared storage system. The first virtual processor identifies the second virtual processor to which the request for metadata is to be sent based on applying a function (e.g., a hash function or another type of function) on an input value including an identifier of the data object. For example, the input value can include an object ID and a bucket ID. The function produces different output values for different input values, where the different output values map to different partitions associated with respective virtual processors of the plurality of virtual processors.

In some examples, the write of the data for the write request to the shared storage system is performed without any exchange of the data between the first virtual processor and any other virtual processor of the plurality of virtual processors.

In some examples, the metadata includes one or more chunk identifiers that represent one or more chunks to store the data. The initiating of the write of the data includes initiating the write of the one or more chunks represented by the one or more chunk identifiers received at the first virtual processor from the second virtual processor.

In some examples, in response to write request, the first virtual processor sends to the second virtual processor an initiate indication indicating that a write of the data is to be initiated. The initiate indication can include an initiation control message (e.g., 302 in FIG. 3). The first virtual processor receives, from the second virtual processor in response to the initiate indication, version information representing a version of the data. The version information can include a version ID (e.g., 306 in FIG. 3).

In some examples, the sending of the request for metadata from the first virtual processor to the second virtual processor is after the updating of the intent structure in the NV memory with the information indicating the intent to write the data for the write request.

In some examples, in response to the request for metadata, the second virtual processor adds an entry to a commit structure (e.g., any of 124-1 to 124-N in FIG. 1) to indicate that write of the data is in progress.

In some examples, the machine-readable instructions detect an anomaly condition, and in response to detecting the anomaly condition, find an entry in the intent structure containing respective information indicating an intent to write a data object. The first virtual processor sends, to a target virtual processor of the plurality of virtual processors, a recovery indication including an identifier of the data object. An example of the recovery indication is an intent-cleanup control message (e.g., 506 in FIG. 5). The first virtual processor receives, from the target virtual processor, a status relating to the data object. The status can be based on a status flag (e.g., 204-1, 204-2, etc., in FIG. 2A). The first virtual processor performs a recovery action in response to the status.

In some examples, the recovery action includes removing the entry from the intent structure.

In some examples, the recovery action includes sending, from the first virtual processor to the target virtual processor, an indication to delete the data object.

In some examples, the recovery action is responsive to the status indicating that a commit structure of the target virtual processor has an entry indicating that a write of the data object is in progress.

In some examples, the machine-readable instructions associate, with each respective request received by a recipient virtual processor from the first virtual processor, a generation indicator that represents a round in which the recipient virtual processor received the respective request. In response to an anomaly, the machine-readable instructions implement a barrier to control execution of the requests received by the recipient virtual processor.

In some examples, the barrier prevents the recipient virtual processor that has received one or more requests in a current round from processing the one or more requests until all control messages in one or more prior rounds have been aborted.

In some examples, the barrier prevents the recipient virtual processor from executing any control messages in any prior round that is before a current round in which the recipient virtual processor has received one or more control messages.

In some examples, the first virtual processor receives a read request to read further data. In response to the read request, the first virtual processor sends, to the second virtual processor, a request for further metadata. The request for further metadata can include the chunk ID control message sent at 402 in FIG. 4, for example. The first virtual processor receives, from the second virtual processor, the further metadata that includes an identifier of a third virtual processor. The third virtual processor can be a data virtual processor. The first virtual processor sends, to the third virtual processor, a request for storage location information of the further data. The request for storage location information can include the storage location control message sent at 408 in FIG. 4, for example.

FIG. 8 is a block diagram of a system 800 according to some examples. The system 800 includes a cluster 801 of computing nodes that execute respective virtual processors 802, 804, and 806 to manage access of data at a shared storage system. A first virtual processor 802 is executable in a first computing node of the cluster of computing nodes to receive, at the first virtual processor 802, a read request to read data. In response to the read request, the first virtual processor 802 sends, to a second virtual processor 804 executable in a second computing node of the cluster of computing nodes, a request for metadata 808. The request for metadata 808 can include the chunk ID control message sent at 402 in FIG. 4, for example.

The first virtual processor 802 receives, from the second virtual processor 804, the metadata 810 including an identifier of a third virtual processor 806. The first virtual processor 802 can be a source virtual processor, the second virtual processor 804 can be a metadata virtual processor, and the third virtual processor 806 can be a data virtual processor.

The first virtual processor 802 sends, to the third virtual processor 806, a request for storage location information 812 of the data. The request for storage location information 812 can include the storage location control message sent at 408 in FIG. 4, for example.

The first virtual processor 802 receives, from the third virtual processor 806 responsive to the request for the storage location information 812, response information 814. The first virtual processor 802 performs a read of the data based on the response information 814.

In some examples, the response information includes the storage location information of the data. In this case, the first virtual processor 802 retrieves the data from the shared storage system using the storage location information. The data is received from the shared storage system without passing through the third virtual processor.

In some examples, the response information includes an indication that the data is stored in a write buffer and not yet flushed to the shared storage system. For example, this response information can include a Data Transfer Required flag. In this case, the first virtual processor 802 establishes a session between the first virtual processor 802 and the third virtual processor 806. The first virtual processor 802 retrieves the data from the shared storage system through the third virtual processor 806 in the session.

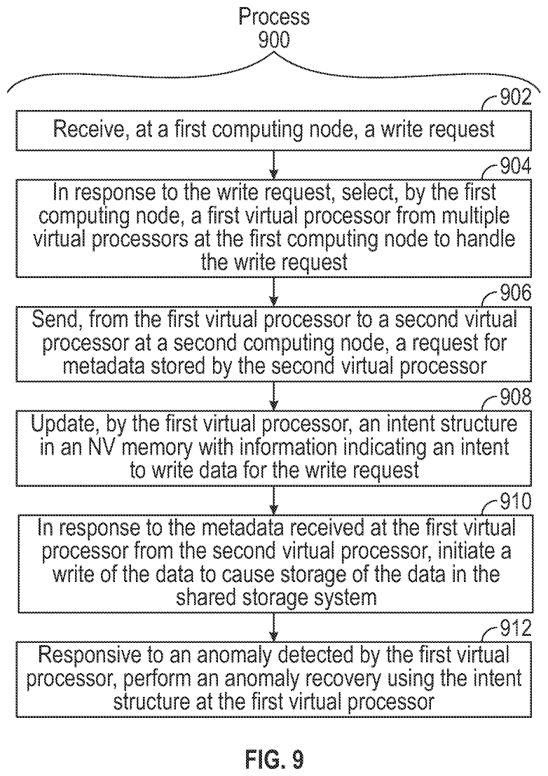

FIG. 9 is a flow diagram of a process 900 according to some examples. The process 900 may be performed by the cluster 100 of computing nodes, for example.

The process 900 includes receiving (at 902), at a first computing node, a write request. The first computing node is part of a collection of multiple computing nodes, and a plurality of virtual processors are executable in the multiple computing nodes to manage access of data in a shared storage system.

The process 900 includes, in response to the write request, selecting (at 904), by the first computing node, a first virtual processor from multiple virtual processors at the first computing node to handle the write request. The selecting is according to a selection process discussed further above.

The process 900 includes sending (at 906), from the first virtual processor to a second virtual processor at a second computing node, a request for metadata stored by the second virtual processor. The request for metadata can include an initiation control message (e.g., 302 in FIG. 3) or a pre-write control message (e.g., 310 in FIG. 3), for example.

The process 900 includes updating (at 908), by the first virtual processor, an intent structure in an NV memory with information indicating an intent to write data for the write request.

The process 900 includes in response to the metadata received at the first virtual processor from the second virtual processor, initiating (at 910) a write of the data to cause storage of the data in the shared storage system.

The process 900 includes, responsive to an anomaly detected by the first virtual processor, performing (at 912) an anomaly recovery using the intent structure at the first virtual processor. The anomaly can include a crash or a loss of a communication link between virtual processors.

A storage medium (e.g., 700 in FIG. 7) can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a processing system to:
receive, at a first computing node, a write request, wherein the first computing node is part of a collection of multiple computing nodes, and wherein a plurality of virtual processors are executable in the multiple computing nodes to manage access of data in a shared storage system;
in response to the write request, send, from a first virtual processor at the first computing node to a second virtual processor, a request for metadata stored by the second virtual processor, wherein the first and second virtual processors are part of the plurality of virtual processors;
update, by the first virtual processor, an intent structure in a nonvolatile memory with information indicating an intent to write data for the write request; and
in response to the metadata received at the first virtual processor from the second virtual processor, initiate a write of the data to cause storage of the data in the shared storage system.

2. The non-transitory machine-readable storage medium of claim 1, wherein the write request is to write a data object to the shared storage system, and wherein the instructions upon execution cause the processing system to:
identify, by the first virtual processor, the second virtual processor to which the request for metadata is to be sent based on applying a function on an input value comprising an identifier of the data object,
wherein the function produces different output values for different input values, wherein the different output values map to different partitions associated with respective virtual processors of the plurality of virtual processors.

3. The non-transitory machine-readable storage medium of claim 1, wherein the write of the data for the write request to the shared storage system is performed without any exchange of the data between the first virtual processor and any other virtual processor of the plurality of virtual processors.

4. The non-transitory machine-readable storage medium of claim 1, wherein the metadata comprises one or more chunk identifiers that represent one or more chunks to store the data, and
wherein the initiating of the write of the data comprises initiating the write of the one or more chunks represented by the one or more chunk identifiers received at the first virtual processor from the second virtual processor.

5. The non-transitory machine-readable storage medium of claim 1, wherein the instructions upon execution cause the processing system to:
in response to write request, send, from the first virtual processor to the second virtual processor, an initiate indication indicating that a write of the data is to be initiated; and
receive, at the first virtual processor from the second virtual processor in response to the initiate indication, version information representing a version of the data.

6. The non-transitory machine-readable storage medium of claim 5, wherein the updating of the intent structure in the nonvolatile memory with the information indicating the intent to write the data for the write request comprises adding an entry to the intent structure, the added entry corresponding to an identifier of the data and the version of the data.

7. The non-transitory machine-readable storage medium of claim 6, wherein the sending of the request for metadata from the first virtual processor to the second virtual processor is after the updating of the intent structure in the nonvolatile memory with the information indicating the intent to write the data for the write request.

8. The non-transitory machine-readable storage medium of claim 7, wherein the instructions upon execution cause the processing system to:
in response to the request for metadata, add, by the second virtual processor, an entry to a commit structure to indicate that write of the data is in progress.

9. The non-transitory machine-readable storage medium of claim 1, wherein the instructions upon execution cause the processing system to:
detect an anomaly condition;
in response to detecting the anomaly condition, find an entry in the intent structure containing respective information indicating an intent to write a data object;
send, from the first virtual processor to a target virtual processor of the plurality of virtual processors, a recovery indication comprising an identifier of the data object;
receive, at the first virtual processor from the target virtual processor, a status relating to the data object; and
perform, at the first virtual processor, a recovery action in response to the status.

10. The non-transitory machine-readable storage medium of claim 9, wherein the recovery action comprises removing the entry from the intent structure.

11. The non-transitory machine-readable storage medium of claim 9, wherein the recovery action comprises sending, from the first virtual processor to the target virtual processor, an indication to delete the data object.

12. The non-transitory machine-readable storage medium of claim 9, wherein the recovery action is responsive to the status indicating that a commit structure of the target virtual processor has an entry indicating that a write of the data object is in progress.

13. The non-transitory machine-readable storage medium of claim 1, wherein the instructions upon execution cause the processing system to:
associate, with each respective request received by a recipient virtual processor from the first virtual processor, a generation indicator that represents a round in which the recipient virtual processor received the respective request; and
in response to an anomaly, implement a barrier to control execution of the requests received by the recipient virtual processor.

14. The non-transitory machine-readable storage medium of claim 13, wherein the barrier prevents the recipient virtual processor that has received one or more requests in a current round from processing the one or more requests until all control messages in one or more prior rounds have been aborted.

15. The non-transitory machine-readable storage medium of claim 13, wherein the barrier prevents the recipient virtual processor from executing any control messages in any prior round that is before a current round in which the recipient virtual processor has received one or more control messages.

16. The non-transitory machine-readable storage medium of claim 1, wherein the instructions upon execution cause the processing system to:
receive, at the first virtual processor, a read request to read further data;
in response to the read request, send, from the first virtual processor to the second virtual processor, a request for further metadata;
receive, at the first virtual processor from the second virtual processor, the further metadata comprising an identifier of a third virtual processor; and
send, from the first virtual processor to the third virtual processor, a request for storage location information of the further data.

17. A system comprising:
a cluster of computing nodes that execute respective virtual processors to manage access of data at a shared storage system,
wherein a first virtual processor is executable in a first computing node of the cluster of computing nodes to:
receive, at the first virtual processor, a read request to read data;
in response to the read request, send, from the first virtual processor to a second virtual processor executable in a second computing node of the cluster of computing nodes, a request for metadata;
receive, at the first virtual processor from the second virtual processor, the metadata comprising an identifier of a third virtual processor;
send, from the first virtual processor to the third virtual processor, a request for storage location information of the data;
receive, at the first virtual processor from the third virtual processor responsive to the request for the storage location information of the data, response information; and
perform a read of the data based on the response information.

18. The system of claim 17, wherein the response information includes the storage location information of the data, and wherein the first virtual processor is executable in the first computing node to:
retrieve, by the first virtual processor, the data from the shared storage system using the storage location information, the retrieved data received from the shared storage system without passing through the third virtual processor.

19. The system of claim 17, wherein the response information includes an indication that the data is stored in a write buffer and not yet flushed to the shared storage system, and wherein the first virtual processor is executable in the first computing node to:
establish a session between the first virtual processor and the third virtual processor; and
retrieve, at the first virtual processor the data from the shared storage system through the third virtual processor in the session.

20. A method comprising:
receiving, at a first computing node, a write request, wherein the first computing node is part of a collection of multiple computing nodes, and wherein a plurality of virtual processors are executable in the multiple computing nodes to manage access of data in a shared storage system;
in response to the write request, selecting, by the first computing node, a first virtual processor from multiple virtual processors at the first computing node to handle the write request;
sending, from the first virtual processor to a second virtual processor at a second computing node, a request for metadata stored by the second virtual processor, wherein the first and second virtual processors are part of the plurality of virtual processors;
updating, by the first virtual processor, an intent structure in a nonvolatile memory with information indicating an intent to write data for the write request;
in response to the metadata received at the first virtual processor from the second virtual processor, initiating a write of the data to cause storage of the data in the shared storage system; and
responsive to an anomaly detected by the first virtual processor, performing an anomaly recovery using the intent structure at the first virtual processor.
